(19) United States
(12) Patent Application Publication
(10) Pub. No.: US 2024/0317378 A1
(43) Pub. Date: Sep. 26, 2024

(54) METHOD OF CONTROLLING UNDERWATER THRUSTER, UNDERWATER THRUSTER AND COMPUTER-READABLE STORAGE MEDIUM

(71) Applicant: SHENZHEN WAYDOO INTELLIGENCE TECHNOLOGY CO., LTD., Shenzhen (CN)

(72) Inventors: Qiuyang ZHU, Shenzhen (CN); Xupeng DUAN, Shenzhen (CN); Tao ZHAO, Shenzhen (CN); Zhi HUANG, Shenzhen (CN)

(73) Assignee: SHENZHEN WAYDOO INTELLIGENCE TECHNOLOGY CO., LTD., Shenzhen (CN)

(21) Appl. No.: 18/737,563

(22) Filed: Jun. 7, 2024

Related U.S. Application Data
(63) Continuation of application No. PCT/CN2022/136484, filed on Dec. 5, 2022.

(30) Foreign Application Priority Data
Dec. 10, 2021 (CN) 202111514215.1

(51) Int. Cl. B63H 21/21; B63H 11/08

(52) U.S. Cl. CPC B63H 21/21; B63H 11/08; B63H 2021/216

(57) ABSTRACT

Disclosed are a method of controlling an underwater thruster, an underwater thruster and a computer-readable storage medium. The control method includes: obtaining a current control parameter and/or a motor control parameter corresponding to an ultra-high power mode when entering the ultra-high power mode; and controlling an operating current of the underwater thruster according to the current control parameter, and/or controlling motor revolutions of the underwater thruster to rotate in a preset mode according to the motor control parameter to control the underwater thruster to operate in the ultra-high power mode. By providing the ultra-high power mode on the underwater thruster, the underwater thruster can output ultra-high power, overcome the problem of slow uplift due to the influence of water flow resistance in the process of underwater operation, and achieve the effect of enhancing the uplift speed.

### CROSS-REFERENCE TO RELATED APPLICATIONS

This application is a continuation of International Application No. PCT/CN2022/136484, filed on Dec. 5, 2022, which claims priority to Chinese Patent Application No. 202111514215.1, filed on Dec. 10, 2021. All of the aforementioned applications are incorporated herein by reference in their entireties.

### TECHNICAL FIELD

The present disclosure herein relates to the technical field of underwater operation equipment, and in particular to a method of controlling an underwater thruster, an underwater thruster and a computer-readable storage medium.

### BACKGROUND

With the gradual exploration of the underwater world by mankind, people engaged in underwater operations have increasingly high requirements for underwater equipment, and common underwater equipment is usually equipped with an underwater thruster, which facilitates the activities of divers or diving robots underwater.

Current underwater thruster is usually provided with a plurality of different gears, different gears under the different output power, whereby the underwater thruster can travel at different speeds.

However, in actual underwater operations, there may be some situations that conventional gears cannot cope with, such as common water flow problems. Divers are easily affected by the resistance generated by water flow during underwater operations, especially during the uplift phase, which usually occurs between 10-20 meters away from the water surface. During this phase, there will be significant downward flow, and divers will be disturbed by significant water flow resistance during the uplift process, resulting in slow uplift speed or even impossible uplift, which can cause trouble and even threaten the safety of divers during underwater operations.

The above content is only intended to assist in understanding the technical solution of the present disclosure and does not imply recognition that the above content belongs to the prior art.

### SUMMARY

The main purpose of the present disclosure is to provide a method of controlling an underwater thruster, aiming at solving the problem of slow uplift speed caused by the interference of water flow resistance in underwater operation.

In order to realize the above object, the present disclosure provides a method of controlling an underwater thruster, comprising:
obtaining a current control parameter and/or a motor control parameter corresponding to an ultra-high power mode when entering the ultra-high power mode; and
controlling an operating current of the underwater thruster according to the current control parameter, and/or controlling motor revolutions of the underwater thruster to rotate in a preset mode according to the motor control parameter, so as to control the underwater thruster to operate in the ultra-high power mode.

Optionally, before obtaining the current control parameter and/or the motor control parameter corresponding to the ultra-high power mode, the method further comprises:
receiving a control signal sent by a controller, the control signal category comprising at least one of a gear switching signal, a constant speed cruise signal, an ultra-high power signal and an exit signal;
determining a target gear corresponding to the gear switching signal and controlling the underwater thruster to operate at the target gear when the control signal category is the gear switching signal;
entering a constant speed cruise mode when the control signal category is the constant speed cruise signal;
entering the ultra-high power mode when the control signal category is the ultra-high power signal; and
exiting the ultra-high power mode or the constant speed cruise mode when the control signal category is the exit signal.

Optionally, after receiving the control signal sent by the controller, the method further comprises:
determining a hopping number, a hopping duration and a hopping interval of a level corresponding to the control signal;
determining that the control signal is the gear switching signal when the hopping number, the hopping duration and the hopping interval of the level satisfy a first condition;
determining that the control signal is the constant speed cruise signal when the hopping number, the hopping duration and the hopping interval of the level satisfy a second condition;
determining that the control signal is the ultra-high power signal when the hopping number, the hopping duration and the hopping interval of the level satisfy a third condition; and
determining that the control signal is the exit signal when the hopping number, the hopping duration and the hopping interval of the level satisfy a fourth condition.

Optionally, the first signal condition is that the hopping number is two and the hopping interval is less than or equal to a preset hopping interval threshold value; the second signal condition is that the hopping number is one and the hopping duration is greater than a preset hopping duration threshold value; the third signal condition is that the hopping number is three and the hopping interval is less than or equal to the hopping interval threshold value; and the fourth signal condition is that the hopping number is one, the hopping duration is less than the hopping duration threshold value, and the underwater thruster is in the constant speed cruise mode or the ultra-high power mode.

Optionally, determining the target gear corresponding to the gear switching signal and controlling the underwater thruster to operate at the target gear comprises:
obtaining a current gear and a gear increment of the underwater thruster, determining a target gear according to the current gear and the gear increment, and controlling the underwater thruster to operate at the target gear; or
obtaining a current operating current of the underwater thruster, determining a target operating current according to the current operating current, and controlling the underwater thruster to operate at the target operating current, and/or obtaining current motor revolutions of the underwater thruster, determining target motor revolutions according to the current motor revolutions, and controlling the underwater thruster to operate at the target motor revolutions.

Optionally, controlling the underwater thruster to enter the constant speed cruise mode comprises:
obtaining a current gear and a motor control parameter increment of the underwater thruster, determining the current operating current and/or current motor revolutions according to the current gear, wherein the motor control parameter increment is a negative value and the motor control parameter increment is provided with a preset duration; and
controlling the underwater thruster to operate at the motor revolutions under the motor control parameter increment according to the motor control parameter increment, and controlling the underwater thruster to operate at the current motor revolutions when an operating duration is greater than or equal to the preset duration, so as to cause the underwater thruster to vibrate and produce sound from the motor by the change in the motor revolutions.

Optionally, controlling the underwater thruster to exit the ultra-high power mode or the constant speed cruise mode comprises:
obtaining an initial current control parameter and/or an initial motor control parameter corresponding to the gear of the underwater thruster before it enters the ultra-high power mode or the constant speed cruise mode; and
controlling the underwater thruster to operate at the operating current and/or the motor revolutions according to the initial current control parameter and/or the initial motor control parameter.

Optionally, the operating current and/or the motor revolutions corresponding to the ultra-high power mode are greater than the operating current and/or the motor revolutions corresponding to a non-ultra-high power mode; after controlling the operating current of the underwater thruster according to the current control parameter, and/or controlling the motor of the underwater thruster to rotate in the preset mode according to the motor control parameter to control the underwater thruster to operate in the ultra-high power mode, the method further comprises:
obtaining an operating duration of the underwater thruster in the ultra-high power mode;
obtaining an initial current control parameter and/or an initial motor control parameter corresponding to the underwater thruster before it enters the ultra-high power mode when the operating duration is greater than or equal to a preset duration; and
controlling the underwater thruster to operate at the operating current and/or the motor revolutions corresponding to a gear before entering the ultra-high power mode.

In addition, to achieve the above objectives, the present disclosure also provides an underwater thruster, comprising a controller, a memory, a processor and a control program for the underwater thruster stored on the memory and operable on the processor, wherein when the control program for the underwater thruster is executed by the processor, steps of the method of controlling the underwater thruster as described above are implemented.

In addition, to achieve the above objectives, the present disclosure also provides a non-transitory computer-readable storage medium having stored thereon a control program for an underwater thruster, wherein when the control program for the underwater thruster is executed by a processor, steps of the method of controlling the underwater thruster as described above are implemented.

The embodiment of the present disclosure provides a method of controlling an underwater thruster, an underwater thruster, and a computer-readable storage medium, wherein obtaining a current control parameter and/or a motor control parameter corresponding to the ultra-high power signal when entering the ultra-high power mode, and then controlling an operating current of the underwater thruster according to the current control parameter, and/or controlling a motor of the underwater thruster to rotate in a preset mode according to the motor control parameter to control the underwater thruster to operate in the ultra-high power mode. By providing the current control parameter and/or motor control parameter corresponding to the ultra-high power mode on the underwater thruster, when the underwater thruster receives the ultra-high power signal according to these control parameters, the underwater thruster can work at an operating current and motor revolutions greater than that under any conventional gear, so as to enable the underwater thruster to output ultra-high power, overcome the problem of slow uplift due to the influence of water flow resistance in the process of underwater operation, and achieve the effect of enhancing the uplift speed.

### BRIEF DESCRIPTION OF THE DRAWINGS

FIG. 1 shows a schematic diagram of a hardware architecture of an underwater thruster involved in an embodiment of the present disclosure.

FIG. 2 shows a flow diagram of a first embodiment of a method of controlling an underwater thruster of the present disclosure.

FIG. 3 shows a flow diagram of a second embodiment of a method of controlling an underwater thruster of the present disclosure.

FIG. 4 shows a refined flow diagram of Step 30 in a third embodiment of a method of controlling an underwater thruster of the present disclosure.

FIG. 5 shows a refined flow diagram of Step 40 in a fourth embodiment of a method of controlling an underwater thruster of the present disclosure.

FIG. 6 shows a refined flow diagram of Step 40 in a fifth embodiment of a method of controlling an underwater thruster of the present disclosure.

FIG. 7 shows a refined flow diagram of Step 40 in a sixth embodiment of a method of controlling an underwater thruster of the present disclosure.

FIG. 8 shows a refined flow diagram of Step 20 in a seventh embodiment of a method of controlling an underwater thruster of the present disclosure.

FIG. 9 shows a flow diagram of entering an ultra-high power mode of a method of controlling an underwater thruster of the present disclosure.

The realization of the objects, functional features and advantages of the present disclosure will be further described in conjunction with the embodiments and with reference to the accompanying drawings.

### DETAILED DESCRIPTION OF THE EMBODIMENTS

The main solution of the embodiment of the present disclosure is: obtaining a current control parameter and/or a motor control parameter corresponding to the ultra-high power mode when entering the ultra-high power mode; and controlling an operating current of the underwater thruster according to the current control parameter, and/or controlling motor revolutions of the underwater thruster to rotate in a preset mode according to the motor control parameter, so as to control the underwater thruster to operate in the ultra-high power mode.

When the underwater thruster receives an ultra-high power signal sent by the controller, it controls the operating current and the motor revolutions inside the underwater thruster according to the current control parameter and the motor control parameter contained in the ultra-high power signal in order to instantaneously increase the output power of the underwater thruster, so as to make it enter the ultra-high power operating mode, which achieves the effect of overcoming the resistance of the water flow.

It should be understood that exemplary embodiments of the present disclosure are shown in the accompanying drawings of the present disclosure, and that the present disclosure may be realized in various forms without being limited by the embodiments described herein. On the contrary, these embodiments are provided to enable a more thorough understanding of the present disclosure and to fully convey the scope of the present disclosure to a person skilled in the art.

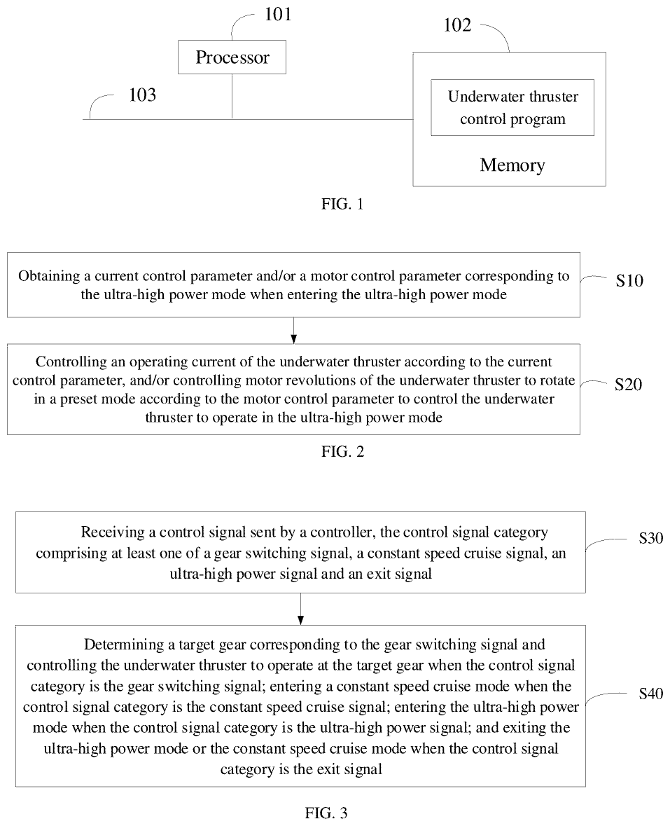

As an embodiment, the hardware architecture of the underwater thruster may be shown in FIG. 1.

The embodiment scheme of the present disclosure relates to an underwater thruster, the underwater thruster comprises: a processor 101, such as a Central Processing Unit (CPU), a memory 102, a communication bus 103, wherein the communication bus 103 is used to enable connected communication between these components.

The memory 102 may be a high-speed Random Access Memory (RAM) memory or a non-volatile memory, such as a disk memory. As shown in FIG. 1, the memory 102, which is a computer-readable storage medium, may include a control program for the underwater thruster; and the processor 101 may be used to call the control program of the underwater thruster stored in the memory 102 and perform the following operations:
obtaining a current control parameter and/or a motor control parameter corresponding to an ultra-high power mode when entering the ultra-high power mode; and
controlling an operating current of the underwater thruster according to the current control parameter, and/or controlling motor revolutions of the underwater thruster to rotate in a preset mode according to the motor control parameter, so as to control the underwater thruster to operate in the ultra-high power mode.

In an embodiment, the processor 101 may be used to call the control program of the underwater thruster stored in the memory 102 and perform the following operations:
receiving a control signal sent by a controller, the control signal category comprising at least one of a gear switching signal, a constant speed cruise signal, an ultra-high power signal and an exit signal;
determining a target gear corresponding to the gear switching signal and controlling the underwater thruster to operate at the target gear when the control signal category is the gear switching signal;
entering a constant speed cruise mode when the control signal category is the constant speed cruise signal;
entering the ultra-high power mode when the control signal category is the ultra-high power signal; and
exiting the ultra-high power mode or the constant speed cruise mode when the control signal category is the exit signal.

In an embodiment, the processor 101 may be used to call the control program of the underwater thruster stored in the memory 102 and perform the following operations:
determining a hopping number, a hopping duration and a hopping interval of a level corresponding to the control signal;
determining that the control signal is the gear switching signal when the hopping number, the hopping duration and the hopping interval of the level satisfy a first condition;
determining that the control signal is the constant speed cruise signal when the hopping number, the hopping duration and the hopping interval of the level satisfy a second condition;
determining that the control signal is the ultra-high power signal when the hopping number, the hopping duration and the hopping interval of the level satisfy a third condition; and
determining that the control signal is the exit signal when the hopping number, the hopping duration and the hopping interval of the level satisfy a fourth condition.

In an embodiment, the processor 101 may be used to call the control program of the underwater thruster stored in the memory 102 and perform the following operations:
obtaining a current gear and a gear increment of the underwater thruster, determining a target gear according to the current gear and the gear increment, and controlling the underwater thruster to operate at the target gear; or
obtaining a current operating current of the underwater thruster, determining a target operating current according to the current operating current, and controlling the underwater thruster to operate at the target operating current, and/or obtaining current motor revolutions of the underwater thruster, determining target motor revolutions according to the current motor revolutions, and controlling the underwater thruster to operate at the target motor revolutions.

In an embodiment, the processor 101 may be used to call the control program of the underwater thruster stored in the memory 102 and perform the following operations:
obtaining a current gear and a motor control parameter increment of the underwater thruster, determining the current operating current and/or current motor revolutions according to the current gear, wherein the motor control parameter increment is a negative value and the motor control parameter increment is provided with a preset duration; and
controlling the underwater thruster to operate at the motor revolutions under the motor control parameter increment according to the motor control parameter increment, and controlling the underwater thruster to operate at the current motor revolutions when an operating duration is greater than or equal to the preset duration, so as to cause the underwater thruster to vibrate and produce sound from the motor by the change in the motor revolutions.

In an embodiment, the processor 101 may be used to call the control program of the underwater thruster stored in the memory 102 and perform the following operations:
obtaining an initial current control parameter and/or an initial motor control parameter corresponding to the gear of the underwater thruster before it enters the ultra-high power mode or the constant speed cruise mode; and
controlling the underwater thruster to operate at the operating current and/or the motor revolutions according to the initial current control parameter and/or the initial motor control parameter.

In an embodiment, the processor 101 may be used to call the control program of the underwater thruster stored in the memory 102 and perform the following operations:
obtaining an operating duration of the underwater thruster in the ultra-high power mode;
obtaining an initial current control parameter and/or an initial motor control parameter corresponding to the underwater thruster before it enters the ultra-high power mode when the operating duration is greater than or equal to a preset duration; and
controlling the underwater thruster to operate at the operating current and/or the motor revolutions corresponding to a gear before entering the ultra-high power mode.

Based on the above hardware architecture of the underwater thruster based on computer technology, an embodiment of a method of controlling an underwater thruster of the present disclosure is proposed.

Referring to FIG. 2, in a first embodiment, the method of controlling the underwater thruster comprises the following steps:
Step 10: obtaining a current control parameter and/or a motor control parameter corresponding to the ultra-high power mode when entering the ultra-high power mode; and
in this embodiment, an ultra-high power signal is preset in the controller of the underwater thruster, and the ultra-high power signal may include at least one of the current control parameter and the motor control parameter, and the underwater thruster, upon receiving the ultra-high power signal, calls the current control parameter and/or the motor control parameter corresponding to the ultra-high power mode to change its own output power.
Step 20: controlling an operating current of the underwater thruster according to the current control parameter, and/or controlling motor revolutions of the underwater thruster to rotate in a preset mode according to the motor control parameter, so as to control the underwater thruster to operate in the ultra-high power mode.

In this embodiment, the current control parameter is used to control the operating current of the underwater thruster, and the motor control parameter is used to control the motor revolutions of the underwater thruster, and the underwater thruster, by receiving the ultra-high power signal, makes the underwater thruster to operate with the operating current and the motor revolutions in the ultra-high power mode according to the corresponding current control parameter and/or motor control parameter in the ultra-high power mode to achieve the purpose of controlling the underwater thruster to enter the ultra-high power mode.

Exemplarily, when the diver ascends to the surface of the water between 10-20 meters, a very strong and short descending current is likely to appear underwater, and the descending current will exert a downward force on the diver, and at this time, the diver sends the ultra-high power signal to the underwater thruster through the controller, and when the underwater thruster receives the ultra-high power signal, according to the current control parameters in the ultra-high power mode, the resistance in the operating circuit will be lowered to 3-5 ohms, in order to increase the operating current to 10-20 amperes and then increase the motor speed to more than 2,000 revolutions per minute, whereby the underwater thruster will increase the output power to more than 500 watts within 10 milliseconds to provide the divers with a larger upward impulse in a short period of time to overcome the downward force of the falling current.

In the technical solution provided in this embodiment, the underwater thruster obtains the corresponding current control parameter and/or motor control parameter according to the ultra-high power signal to change its own operating current and motor revolutions, and thus change the output power of the underwater thruster, realizing the preset modes such as the ultra-high power mode to provide a solution for the underwater thruster when it encounters a situation requiring an instantaneous increase of the power gear, and to improve the applicability of the underwater thruster.

Referring to FIG. 3, in the second embodiment, based on the first embodiment, before the Step 10, the method further comprises:
Step 30: receiving a control signal sent by a controller, the control signal category comprising at least one of a gear switching signal, a constant speed cruise signal, an ultra-high power signal and an exit signal;
Step 40: determining a target gear corresponding to the gear switching signal and controlling the underwater thruster to operate at the target gear when the control signal category is the gear switching signal; entering a constant speed cruise mode when the control signal category is the constant speed cruise signal; entering the ultra-high power mode when the control signal category is the ultra-high power signal; and exiting the ultra-high power mode or the constant speed cruise mode when the control signal category is the exit signal.

In this embodiment, the control mode of the underwater thruster may include, but is not limited to: a switching gear, a constant speed cruise mode, an ultra-high power mode, and an exiting the current mode. Compared to the conventional underwater thruster device, the underwater thruster in the embodiment is preset with the constant speed cruise mode and the ultra-high power mode, and a control method for these two modes is provided, in the constant speed cruise mode, the operating current of the underwater thruster is constant, and the motor is operated at a certain fixed revolutions, and the speed of the underwater thruster can be maintained at a constant speed without any control of the underwater thruster in the meantime; whereas, in the ultra-high power mode, the operating current of the underwater thruster is increased, the motor revolutions increases, and the output power of the underwater thruster is increased rapidly, providing a strong power instantaneously.

Furthermore, for the operation mode of the underwater thruster in a conventional situation, the underwater thruster in this embodiment is preset with a plurality of gears, and the underwater thruster receives signals from different gears to make the underwater thruster at different output powers, whereby the underwater thruster travels at different rates.

Furthermore, for the situation when the diver needs to exit in the ultra-high power mode or the constant speed cruise mode, the embodiment provides an exit signal for exiting the current mode, for causing the underwater thruster to exit the above operation mode.

In the technical solution provided in this embodiment, the underwater thruster carries out a control method of switching gears, entering the constant speed cruise mode, entering the ultra-high power mode and exiting the current mode by receiving the switching gear signal, the constant speed cruise signal, the ultra-high power signal and the exit signal, respectively, so as to provide different operation modes for different underwater operation situations, and to improve the applicability of the underwater thruster.

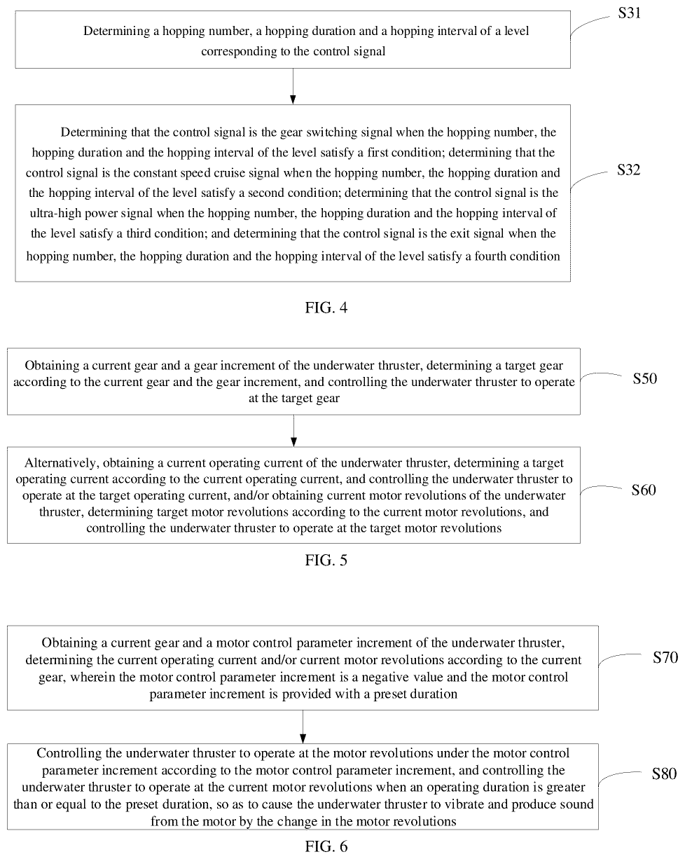

Referring to FIG. 4, in a third embodiment, based on the first or second embodiment, the Step 30 comprises:
Step 31: determining a hopping number, a hopping duration and a hopping interval of a level corresponding to the control signal; and
Step 32: determining that the control signal is the gear switching signal when the hopping number, the hopping duration and the hopping interval of the level satisfy a first condition; determining that the control signal is the constant speed cruise signal when the hopping number, the hopping duration and the hopping interval of the level satisfy a second condition; determining that the control signal is the ultra-high power signal when the hopping number, the hopping duration and the hopping interval of the level satisfy a third condition; and determining that the control signal is the exit signal when the hopping number, the hopping duration and the hopping interval of the level satisfy a fourth condition.

The embodiment provides a way of identifying a control signal sent by the controller, in which the underwater thruster, after acquiring the control signal, identifies a signal category corresponding to the control signal based on the conditions of the corresponding level hopping number, the hopping duration, and the hopping interval in the signal, so as to call a program under the corresponding signal category within the underwater thruster to execute the control after determining the signal category.

Exemplarily, the controller is provided with a function-integrated button that sends a level signal of a corresponding waveform according to the number of times, the interval, or the duration of being pressed, and the underwater thruster recognizes the signal as a known signal when the level signal satisfies the preset signal recognition conditions. Furthermore, the first signal condition may be that the level hopping number is two and the hopping interval is less than or equal to a preset hopping interval threshold value, i.e., the button is quickly pressed twice within a certain time, then the underwater thruster recognizes the signal as the gear switching signal, and the hopping interval may be defined by the manufacturer, and it may be an arbitrary interval of less than 1 second; the second signal condition may be that the hopping number is one and the hopping duration is greater than a preset hopping duration threshold value, i.e., the button is pressed and exceeds a certain time, the underwater thruster recognizes the signal as the constant speed cruise signal, and the pressing time can be 1 or 2 seconds; the third signal condition may be that the hopping number is three and the hopping interval is less than or equal to the hopping interval threshold value, i.e., the button is pressed three times quickly within a certain time, the underwater thruster recognizes the signal as the ultra-high power signal, and the pressing time can be any interval within 0.5 seconds or 0.1 seconds; the fourth signal condition may be that the underwater thruster is in the constant speed cruise mode or the ultra-high power mode, the hopping number is one, and the hopping duration is less than the hopping duration threshold value, i.e., when the button is pressed once when the underwater thruster is in a special mode, the underwater thruster recognizes the signal as the exit signal.

In the technical solution provided in this embodiment, by determining the hopping time, hopping duration, and hopping interval of the level corresponding to the control signal to recognize the control signal of the unused categories, the user can complete the control of multiple modes of the underwater thruster by a single button, simplifying the control of the underwater thruster, and reducing the complexity of the operation of the underwater thruster.

Referring to FIG. 5, in a fourth embodiment, based on any of the above embodiments, the Step 40 comprises:
Step 50: obtaining a current gear and a gear increment of the underwater thruster, determining a target gear according to the current gear and the gear increment, and controlling the underwater thruster to operate at the target gear; or
Step 60: obtaining a current operating current of the underwater thruster, determining a target operating current according to the current operating current, and controlling the underwater thruster to operate at the target operating current, and/or obtaining current motor revolutions of the underwater thruster, determining target motor revolutions according to the current motor revolutions, and controlling the underwater thruster to operate at the target motor revolutions.

The embodiment provides a control method for switching an underwater thruster gear, wherein when the underwater thruster acquires the switching gear signal, it first determines a current gear as well as a gear increment, and then determines a target gear to be switched by the underwater thruster, and then finally switches the current gear to the target gear, so as to cause the underwater thruster to operate at a parameter under the target gear. Furthermore, the higher the gear, the higher the corresponding output power of the underwater thruster and the higher the traveling rate. When the underwater thruster receives the gear switching signal, the underwater thruster acquires the current control parameter and/or the motor control parameter under the target gear of the higher gear according to the gear increment, so as to raise its own current magnitude and/or motor revolutions by one gear as well, and so on.

It should be emphasized that when the gear of the underwater thruster is in the highest of the preset gears, i.e., the current control parameter and/or the motor control parameter is already the preset highest value, and then when the gear switching signal is received again at this time, the gear will be set to the lowest of the preset gears according to the gear increment, i.e., the control parameter will be adjusted to the preset lowest value, and then the gear will be raised again from the lowest gear, and so on and so forth.

Exemplarily, the underwater thruster is provided with 3 gears, the underwater thruster is in first gear by default at power-on, when the underwater thruster receives the gear switching signal, the gear incremental value is 1 (i.e., each time a gear is increased), according to the gear incremental value, the gear is set to the second gear, the gear switching signal is received again, the gear is set to the 3 gear, which is already under the highest gear of the underwater thruster, and when the gear switching signal is received again, the gear incremental value changes from 1 to 3, setting the gear to the first gear, and so on and so forth.

In the technical solution provided in this embodiment, by first determining the current gear and the gear increment, and then determining the target gear for the underwater thruster switching, and then finally switching the current gear to the target gear, the underwater thruster is able to cyclically switch the gear according to the actual demand in the process of using the underwater thruster, which enhances the applicability of the underwater thruster.

Referring to FIG. 6, in a fifth embodiment, based on any of the above embodiments, the Step 40 comprises:
Step 70: obtaining a current gear and a motor control parameter increment of the underwater thruster, determining the current operating current and/or current motor revolutions according to the current gear, wherein the motor control parameter increment is a negative value and the motor control parameter increment is provided with a preset duration; and
Step 80: controlling the underwater thruster to operate at the motor revolutions under the motor control parameter increment according to the motor control parameter increment, and controlling the underwater thruster to operate at the current motor revolutions when an operating duration is greater than or equal to the preset duration, so as to cause the underwater thruster to vibrate and produce sound from the motor by the change in the motor revolutions.

This embodiment provides a control method in a constant speed cruise mode, wherein when the underwater thruster acquires a constant speed cruise signal from the controller, the underwater thruster maintains a constant operating current and/or motor revolutions in a current gear (the gear may be any one of a low to a high gear under a conventional gear) so as to keep it traveling at a constant rate.

Exemplarily, when the diver is in an underwater operation state, such as underwater detection, salvage, cleaning, and other projects that require both hands to work at the same time, the diver can turn on the constant speed cruise mode through the controller buttons, and the controller sends the constant speed cruise signal to the underwater thruster, and at this time, the underwater thruster acquires the corresponding current control parameter and/or the motor control parameter under the current gear, and fixes the motor revolutions of the underwater thruster at the revolutions under the current gear, and the underwater thruster maintains the current traveling rate, and the diver's hands can be released from all the control buttons in order to free his/her hands to carry out the underwater operation.

Furthermore, the embodiment also provides a prompting method for entering the constant speed cruise mode, in which when the constant speed cruise mode is activated, the motor revolutions in the underwater thruster will undergo a short jump and then return to the original revolutions, in which the motor fan of the underwater thruster undergoes a short vibration due to the change of the revolutions, in order to drive the body of the underwater thruster to resonate, and at the same time, the revolutions of the motor fan will emit a buzzing sound that is different from that of the normal rotation of the motor due to the change of the frequency of the vibration, and the vibration of the body and the buzzing sound emitted by the motor fan are used to prompt the user that the underwater thruster has entered the constant speed cruise mode at this time.

In the technical solution provided in this embodiment, the constant speed cruise mode is entered by fixing the operating current and/or the motor revolutions of the underwater thruster, and the vibration and sound are emitted to remind the user that the mode has been entered by decreasing the revolutions of the motor and recovering it quickly. While facilitating underwater operation by divers, the characteristics of the motor when the underwater thruster enters the constant speed cruise mode are utilized to complete the prompting of the user without having to additionally install a sound device or a light device on the underwater thruster, which improves the applicability of the underwater thruster under the premise of minimizing the development cost and the volume of the underwater thruster.

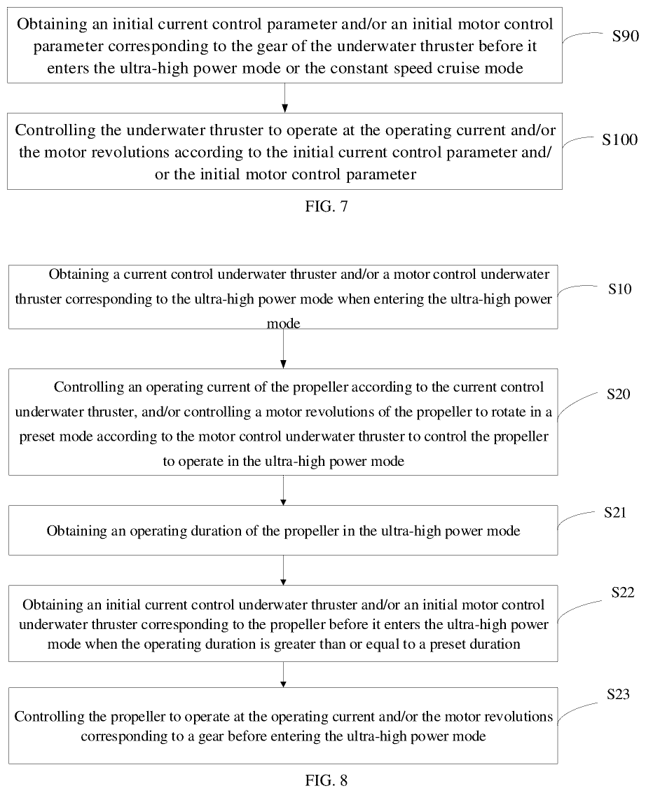

Referring to FIG. 7, in a sixth embodiment, based on any of the above embodiments, the Step 40 comprises:
Step 90: obtaining an initial current control parameter and/or an initial motor control parameter corresponding to the gear of the underwater thruster before it enters the ultra-high power mode or the constant speed cruise mode; and
Step 100: controlling the underwater thruster to operate at the operating current and/or the motor revolutions according to the initial current control parameter and/or the initial motor control parameter.

This embodiment provides a control method for exiting the constant speed cruise mode or the ultra-high power mode, in this embodiment, when the underwater thruster receives the exit signal from the controller, the underwater thruster calls up the current control parameter and/or the motor control parameter corresponding to the gear before entering the ultra-high power mode or before entering the constant speed cruise mode. When the underwater thruster exits from the ultra-high power mode, it calls up the control parameter corresponding to the gear saved to a latch before entering the mode, sets the operating current and/or the motor revolutions of the underwater thruster to the corresponding values under the control parameter of the gear, i.e., it switches from the ultra-high power gear to the conventional gear; when the underwater thruster exits from the cruise mode, since the gear of the underwater thruster remains unchanged when it enters the constant speed cruise mode. Therefore, the control parameters invoked when exiting the constant speed cruise mode remain unchanged. It should be emphasized that when the underwater thruster exits the cruise control mode, the motor revolutions will also briefly jump to generate vibration and sound to send prompts to the user.

In the technical solution provided in this embodiment, the maneuverability and applicability of the underwater thruster is enhanced by setting the exit signal so that it can exit at any time when the user needs to exit the ultra-high power mode or the constant speed cruise mode, and it will switch to the gear where it was before entering the mode after exiting.

Referring to FIG. 8, in a seventh embodiment, based on any of the above embodiments, after the Step 20, the step further comprises:
Step 21: obtaining an operating duration of the underwater thruster in the ultra-high power mode;
Step 22: obtaining an initial current control parameter and/or an initial motor control parameter corresponding to the underwater thruster before it enters the ultra-high power mode when the operating duration is greater than or equal to a preset duration; and
Step 23: controlling the underwater thruster to operate at the operating current and/or the motor revolutions corresponding to a gear before entering the ultra-high power mode.

This embodiment provides a way of limiting the underwater thruster from consuming energy too fast in the ultra-high power mode, in this embodiment, the underwater thruster is provided with a timer and a limiting duration is preset in the timer, and the operating duration of the underwater thruster in the ultra-high power mode is obtained by obtaining a value in the timer, and when the timer value reaches the preset limiting duration, the initial current control parameter and/or initial motor control parameter corresponding to the underwater thruster before it enters the ultra-high power mode is obtained, and according to these parameters, operate the underwater thruster at the current and/or revolutions size before entering the ultra-high power mode.

Exemplarily, the underwater thruster is provided with a timer, and the timer is provided with a limit time of about 20 seconds, and when the underwater thruster enters the ultra-high power mode, the timer receives a signal to start timing, at this time the timer starts timing from zero, and the underwater thruster is operated at the operating current and/or motor revolutions corresponding to the ultra-high power mode, and the resistance in the operating circuit will be lowered to 3-5 ohms to increase the operating current to 10-20 amperes and then increase the motor speed to more than 2,000 revolutions per minute, whereby the underwater thruster will increase the output power to more than 500 watts within 10 milliseconds, stopping the timing when the timing has reached 20 seconds and recalling the corresponding operating parameter in the corresponding gear before entering the ultra-high power mode, restoring the resistance in the operating circuits to 10-20 ohms in the regular gear, and restoring the operating current to 3-5 amperes, the motor revolutions are reduced to 500-1500 revolutions per minute, and the underwater thruster output power increased from 180 W to 480 W.

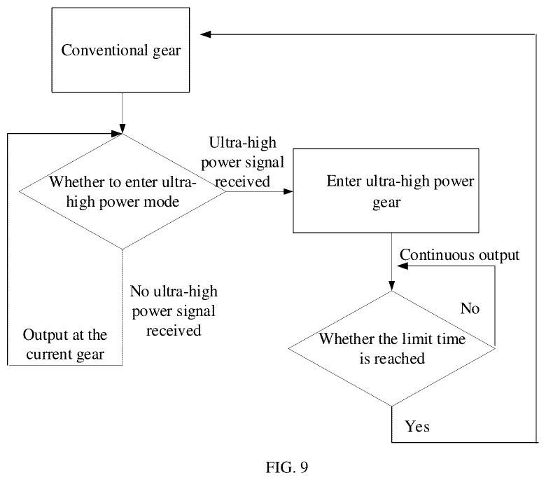

Exemplarily, referring to FIG. 9, which shows a flow diagram of the underwater thruster enters the ultra-high power mode. When the underwater thruster is operating in a conventional gear, there is no time limit under any gear, and in the process of using the underwater thruster, when the underwater thruster receives the ultra-high power signal, the underwater thruster can be adjusted to the ultra-high power gear at any time, whereby the underwater thruster operates at a power greater than that under any conventional gear, and there is a limitation time after entering the ultra-high power gear, and when it is judged that the underwater thruster has reached the limitation time under the ultra-high power mode, the underwater thruster is switched to the original conventional gear before entering the ultra-high power gear, the underwater thruster continues to operate at that conventional gear.

In the technical solution provided in this embodiment, by obtaining the use time of the underwater thruster in the ultra-high power mode and exiting the ultra-high power mode when the use time exceeds the preset limiting time, the problem of excessive heating of the batteries and motors of the underwater thruster due to the prolonged presence of the underwater thruster in the ultra-high power mode is avoided, and the use time of the underwater thruster underwater is improved.

In addition, the present disclosure provides an underwater thruster, the underwater thruster comprises a controller, a memory, a processor and a control program for the underwater thruster stored on the memory and operable on the processor, wherein when the control program for the underwater thruster is executed by the processor, steps of the method of controlling the underwater thruster as described above are implemented.

In addition, the present disclosure provides a non-transitory computer-readable storage medium having stored thereon a control program for an underwater thruster, wherein when the control program for the underwater thruster is executed by a processor, steps of the method of controlling the underwater thruster as described in the above embodiment are implemented.

It is noted that in this document, the terms “including”, “comprising”, or any other variant thereof, are intended to cover non-exclusive inclusion, such that a process, method, article or device comprising a set of elements includes not only those elements, but also other elements that are not explicitly listed, or that are inherent to such process, method, article or device. Without further limitation, the fact that an element is defined by the statement “including a . . . ” does not exclude the existence of another identical element in the process, method, article, or device including that element.

By the above description of the embodiments, it is clear to a person skilled in the art that the method of the above embodiments can be realized by means of software and the necessary general hardware platform, or of course by means of hardware, but in many cases the former is the preferred embodiment. Based on this understanding, the technical solution of the present disclosure may be embodied in the form of a software product, which is stored in a computer-readable storage medium (e.g., Read Only Memory (ROM)/Random Access Memory (RAM), disk, Compact Disk (CD)) as described above, and includes a plurality of instructions to enable a terminal device (which may be a cellular phone, a computer, a server, an air-conditioner, or a network device, etc.) to carry out the method described in the various embodiments of the present disclosure.

The above is only a preferred embodiment of the present disclosure, and is not intended to limit the scope of the patent of the present disclosure. Any equivalent structure or equivalent process transformations utilizing the contents of the specification of the present disclosure and the accompanying drawings, or directly or indirectly applying them in other related technical fields, are equally included in the scope of patent protection of the present disclosure.

What is claimed is:

1. A method of controlling an underwater thruster, comprising:
obtaining a current control parameter and/or a motor control parameter corresponding to an ultra-high power mode when entering the ultra-high power mode; and
controlling an operating current of the underwater thruster according to the current control parameter, and/or controlling motor revolutions of the underwater thruster to rotate in a preset mode according to the motor control parameter to control the underwater thruster to operate in the ultra-high power mode.

2. The method of controlling the underwater thruster according to claim 1, wherein before obtaining the current control parameter and/or the motor control parameter corresponding to the ultra-high power mode when entering the ultra-high power mode, the method further comprises:
receiving a control signal sent by a controller, the control signal category comprising at least one of a gear switching signal, a constant speed cruise signal, an ultra-high power signal and an exit signal;
determining a target gear corresponding to the gear switching signal and controlling the underwater thruster to operate at the target gear when the control signal category is the gear switching signal;
entering a constant speed cruise mode when the control signal category is the constant speed cruise signal;
entering the ultra-high power mode when the control signal category is the ultra-high power signal; and
exiting the ultra-high power mode or the constant speed cruise mode when the control signal category is the exit signal.

3. The method of controlling the underwater thruster according to claim 2, wherein after receiving the control signal sent by the controller, the method further comprises:
determining a hopping number, a hopping duration and a hopping interval of a level corresponding to the control signal;
determining that the control signal is the gear switching signal when the hopping number, the hopping duration and the hopping interval of the level satisfy a first condition;
determining that the control signal is the constant speed cruise signal when the hopping number, the hopping duration and the hopping interval of the level satisfy a second condition;
determining that the control signal is the ultra-high power signal when the hopping number, the hopping duration and the hopping interval of the level satisfy a third condition; and
determining that the control signal is the exit signal when the hopping number, the hopping duration and the hopping interval of the level satisfy a fourth condition.

4. The method of controlling the underwater thruster according to claim 3, wherein the first condition is that the hopping number is two and the hopping interval is less than or equal to a preset hopping interval threshold value; the second condition is that the hopping number is one and the hopping duration is greater than a preset hopping duration threshold value; the third condition is that the hopping number is three and the hopping interval is less than or equal to the hopping interval threshold value; and the fourth condition is that the hopping number is one, the hopping duration is less than the hopping duration threshold value, and the underwater thruster is in the constant speed cruise mode or the ultra-high power mode.

5. The method of controlling the underwater thruster according to claim 2, wherein determining the target gear corresponding to the gear switching signal and controlling the underwater thruster to operate at the target gear comprises:
obtaining a current gear and a gear increment of the underwater thruster, determining a target gear according to the current gear and the gear increment, and controlling the underwater thruster to operate at the target gear.

6. The method of controlling the underwater thruster according to claim 2, wherein determining the target gear corresponding to the gear switching signal and controlling the underwater thruster to operate at the target gear comprises:
obtaining a current operating current of the underwater thruster, determining a target operating current according to the current operating current, and controlling the underwater thruster to operate at the target operating current, and/or obtaining current motor revolutions of the underwater thruster, determining target motor revolutions according to the current motor revolutions, and controlling the underwater thruster to operate at the target motor revolutions.

7. The method of controlling the underwater thruster according to claim 2, wherein controlling the underwater thruster to enter the constant speed cruise mode comprises:
obtaining a current gear and a motor control parameter increment of the underwater thruster, determining the current operating current and/or current motor revolutions according to the current gear, wherein the motor control parameter increment is a negative value and the motor control parameter increment is provided with a preset duration; and
controlling the underwater thruster to operate at the motor revolutions under the motor control parameter increment according to the motor control parameter increment, and controlling the underwater thruster to operate at the current motor revolutions when an operating duration is greater than or equal to the preset duration, so as to cause the underwater thruster to vibrate and produce sound from the motor by the change in the motor revolutions.

8. The method of controlling the underwater thruster according to claim 2, wherein controlling the underwater thruster to exit the ultra-high power mode or the constant speed cruise mode comprises:
obtaining an initial current control parameter and/or an initial motor control parameter corresponding to the gear of the underwater thruster before it enters the ultra-high power mode or the constant speed cruise mode; and
controlling the underwater thruster to operate at the operating current and/or the motor revolutions according to the initial current control parameter and/or the initial motor control parameter.

9. The method of controlling the underwater thruster according to claim 1, wherein the operating current and/or the motor revolutions corresponding to the ultra-high power mode are greater than the operating current and/or the motor revolutions corresponding to a non-ultra-high power mode; after controlling the operating current of the underwater thruster according to the current control parameter, and/or controlling the motor of the underwater thruster to rotate in the preset mode according to the motor control parameter to control the underwater thruster to operate in the ultra-high power mode, the method further comprises:
obtaining an operating duration of the underwater thruster in the ultra-high power mode;
obtaining an initial current control parameter and/or an initial motor control parameter corresponding to the underwater thruster before it enters the ultra-high power mode when the operating duration is greater than or equal to a preset duration; and
controlling the underwater thruster to operate at the operating current and/or the motor revolutions corresponding to a gear before entering the ultra-high power mode.

10. An underwater thruster, comprising a controller, a memory, a processor and a control program for the underwater thruster stored on the memory and operable on the processor, wherein when the control program for the underwater thruster is executed by the processor, steps of the method of controlling the underwater thruster according to claim 1 are implemented.

11. A non-transitory computer-readable storage medium having stored thereon a control program for an underwater thruster, wherein when the control program for the underwater thruster is executed by a processor, steps of the method of controlling the underwater thruster according to claim 1 are implemented.
